(19) United States
(12) Patent Application Publication
(10) Pub. No.: US 2026/0175729 A1
(43) Pub. Date: Jun. 25, 2026

(54) ESTIMATION METHOD AND METHOD OF CONTROLLING INFORMATION TERMINAL

(71) Applicant: Panasonic Intellectual Property Management Co., Ltd., Osaka (JP)

(72) Inventor: JUN HIRANO, Osaka (JP)

(21) Appl. No.: 19/541,460

(22) Filed: Feb. 17, 2026

Related U.S. Application Data
(63) Continuation of application No. PCT/JP2024/042716, filed on Dec. 3, 2024.

(30) Foreign Application Priority Data
Jan. 22, 2024 (JP) 2024-007448

(51) Int. Cl. B60L 53/65; B60L 53/66; B60L 53/68

(52) U.S. Cl. CPC B60L 53/65; B60L 53/665; B60L 53/68

(57) ABSTRACT

An estimation method of the present disclosure includes: receiving, from an information terminal of a user of an electric vehicle, information indicating that wireless communication between a device provided in the electric vehicle and the information terminal is enabled; receiving, from the information terminal, information indicating that wireless communication between the device and the information terminal is disabled; receiving positional information of the information terminal from the information terminal; estimating a travel distance of the electric vehicle based on the information indicating that the wireless communication is enabled, the information indicating that the wireless communication is disabled, and the positional information of the information terminal; and estimating SOC of a power storage device mounted on the electric vehicle based on the estimated travel distance of the electric vehicle.

### BACKGROUND

### 1. Technical Field

The present disclosure relates to an estimation method and a method of controlling an information terminal.

### 2. Description of the Related Art

Japanese Unexamined Patent Application Publication No. 2021-083187 states a technique related to power storage device. Specifically, Japanese Unexamined Patent Application Publication No. 2021-083187 states calculation of SOC of a power storage device using the voltage and current of the power storage device.

### SUMMARY

One non-limiting and exemplary embodiment provides a technique suitable for estimating, outside an information management system, information on SOC of a power storage device mounted on an electric mobility, the information management system being capable of acquiring state information of the power storage device from a memory in the power storage device.

In one general aspect, the techniques disclosed here feature an estimation method including: receiving, from an information terminal of a user of an electric vehicle, information indicating that wireless communication between a device provided in the electric vehicle and the information terminal is enabled; receiving, from the information terminal, information indicating that wireless communication between the device and the information terminal is disabled; receiving positional information of the information terminal from the information terminal; estimating a travel distance of the electric vehicle based on the information indicating that the wireless communication is enabled, the information indicating that the wireless communication is disabled, and the positional information of the information terminal; and estimating SOC of a power storage device mounted on the electric vehicle based on the estimated travel distance of the electric vehicle.

The technique according to the present disclosure is suitable for estimating, outside an information management system, information on SOC of a power storage device mounted on an electric mobility, the information management system being capable of acquiring state information of the power storage device from a memory in the power storage device.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic explanatory illustration of estimation of SOC of a power storage device of an electric vehicle according to Embodiment 1;

FIG. 2 is a system configuration diagram according to Embodiment 1;

FIG. 3 is a flowchart for explaining the control by communication software according to Embodiment 1;

FIG. 4 is a flowchart for explaining the control by first software according to Embodiment 1;

FIG. 5 is a flowchart for explaining estimation of SOC of a power storage device by a vehicle management system according to Embodiment 1;

FIG. 6 is a flowchart for explaining the control by second software according to Embodiment 2;

FIG. 7 is a flowchart for explaining estimation of SOC of a power storage device by a vehicle management system according to Embodiment 2;

FIG. 8 is a flowchart for explaining the control by third software; and

FIG. 9 is a flowchart for explaining the control by fourth software.

### DETAILED DESCRIPTIONS

### Underlying Knowledge Forming Basis of the Present Disclosure

An information management system including an electric transportation (hereinafter referred to as an electric mobility) equipped with a power storage device is discussed. In the information management system, it is possible share state information (for example, information on SOC) of the power storage device, held in a memory in the power storage device with various pieces of equipment connected to a network in the information management system. For example, the state information can be managed in the electric mobility. When the information management system includes a dedicated terminal that communicates with the electric mobility, it is possible to retrieve the state information from the electric mobility to the dedicated terminal, and manage the state information in the dedicated terminal.

Meanwhile, the information management system may have specifications which prohibit information on the information management system from being retrieved by any external terminal not connected to a network in the information management system. In this case, it is difficult for application of a third party to access the information on the information management system. Thus, it is not necessarily easy to estimate, outside the information management system, information on SOC of the power storage device mounted on the electric mobility, the information management system being capable of acquiring state information of the power storage device from a memory in the power storage device. Thus, the inventor has studied a technique suitable for estimating, outside the information management system, information related to SOC of the power storage device mounted on the electric mobility, the information management system being capable of acquiring state information of the power storage device from a memory in the power storage device.

Hereinafter, an embodiment of the present disclosure will be described with reference to the drawings. The present disclosure is not limited to the following embodiments.

### Embodiment 1

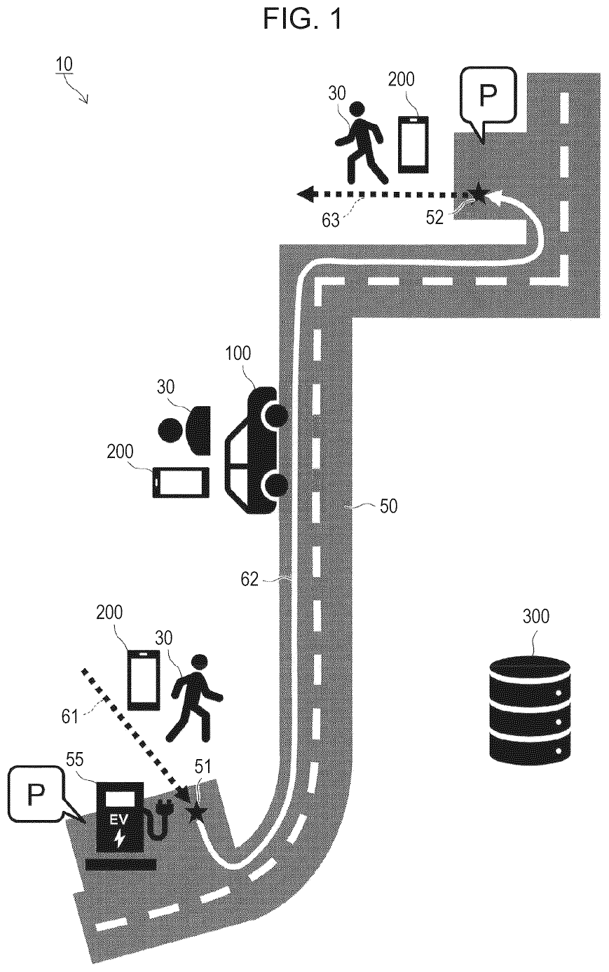

FIG. 1 is a schematic explanatory illustration of estimation of State of Charge (SOC) of a power storage device of an electric vehicle according to Embodiment 1. An environment 10 illustrated in FIG. 1 will be generally described as follows. In FIG. 1, a user 30 is a user of an electric vehicle 100. A mobile terminal 200 is a mobile terminal of the user 30. A location 51 and a location 52 are located in a parking lot. The user 30 with the mobile terminal 200 travels in the electric vehicle 100 from the location 51 to the location 52 along a road 50. The mobile terminal 200 transmits positional information of the electric vehicle 100 to a vehicle management system 300. The vehicle management system 300 estimates SOC based on the positional information.

In Embodiment 1, the SOC of a power storage device is an index to represent the charge level of the power storage device. Specifically, the SOC of the power storage device is the percentage expression of the ratio of the charge amount (Wh) of the power storage device to the capacity (Wh) of the power storage device.

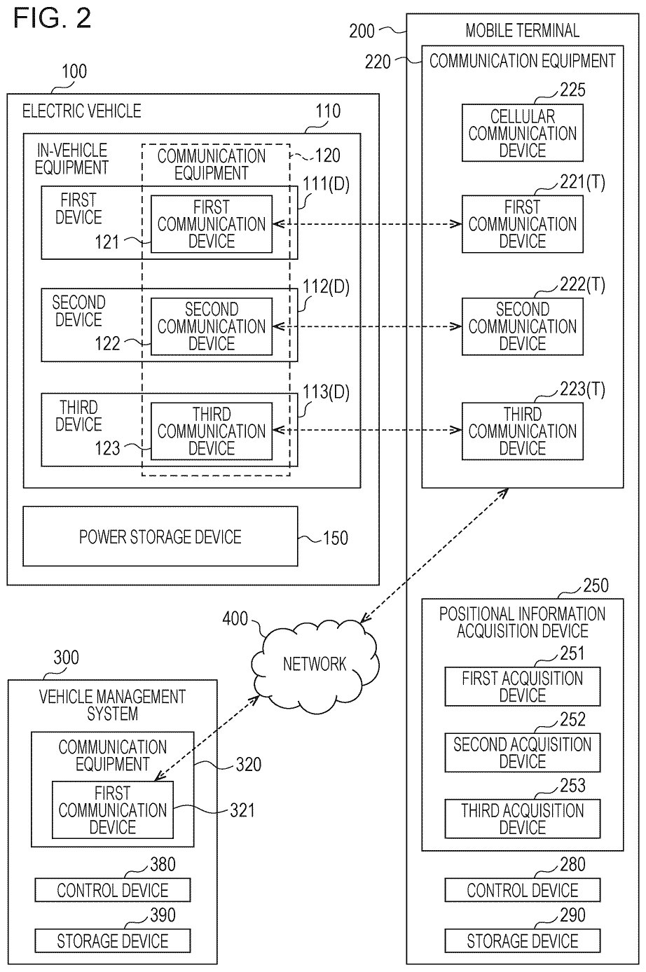

FIG. 2 is a system configuration diagram according to Embodiment 1.

The electric vehicle 100 is an electric transportation having at least one wheel. The electric vehicle 100 may be a four-wheel electric vehicle or a two-wheel electric vehicle.

The electric vehicle 100 includes in-vehicle equipment 110, a communication equipment 120 and a power storage device 150. The in-vehicle equipment 110 includes a first device 111, a second device 112 and a third device 113. The communication equipment 120 includes a first communication device 121, a second communication device 122 and a third communication device 123. The first communication device 121 is included in the first device 111. The second communication device 122 is included in the second device 112. The third communication device 123 is included in the third device 113.

In Embodiment 1, the first device 111 is a device related to entertainment, for example, a car stereo. The second device 112 is a device that holds the mobile terminal 200, for example, a mobile terminal holder. The third device 113 is an in-vehicle camera.

In Embodiment 1, the first communication device 121 is Bluetooth (registered trademark) communication device. The second communication device 122 is a radio frequency (RF) tag communication device. The third communication device 123 is a Wireless Fidelity (WiFi, registered trademark) communication device.

In Embodiment 1, the power storage device 150 is a storage battery. The storage battery is e.g., a lithium-ion secondary battery.

The power storage device 150 includes a memory which is not illustrated. The memory may hold the state information of the power storage device 150. The state information includes information on the SOC of the power storage device 150. The information on the SOC includes the SOC itself.

In Embodiment 1, an information management system is constructed, which can retrieve the information stored in the memory of the power storage device 150 in the environment 10. In the information management system, it is possible to share the state information held in the memory of the power storage device 150 with various pieces of equipment connected to a network in the information management system. For example, in the information management system, it is possible to acquire the state information through a communication device (not illustrated) of the electric vehicle 100 with the power storage device 150, and to hold the state information in a memory (not illustrated) of the electric vehicle 100. The information management system may include an information terminal or a server which can communicate with the communication device of the electric vehicle 100, and the information terminal or the server can also acquire the state information. In this case, the state information can be retrieved from the memory of the electric vehicle 100, and held in the information terminal or the server.

Meanwhile, in Embodiment 1, the information management system has specifications which prohibit information on the information management system from being retrieved by any external terminal not connected to a network in the information management system. However, as understood from the description below, in Embodiment 1, information on the SOC of the power storage device 150 can be estimated outside the information management system. In Embodiment 1, the mobile terminal 200 and the vehicle management system 300 are provided outside the information management system.

The mobile terminal 200 is a terminal that can perform cellular system wireless communication. The cellular system is a wireless communication system in which an area is divided into certain partitions (cells), and a base station is placed in each cell. The mobile terminal 200 is e.g., a smartphone, a cellular phone and the like.

The mobile terminal 200 includes communication equipment 220, a positional information acquisition device 250, a control device 280 and a storage device 290. The communication equipment 220 includes a cellular communication device 225, a first communication device 221, a second communication device 222 and a third communication device 223. The positional information acquisition device 250 includes a first acquisition device 251, a second acquisition device 252 and a third acquisition device 253.

In Embodiment 1, the first communication device 221 is a Bluetooth communication device. The second communication device 222 is an RF tag communication device. The third communication device 223 is a WiFi communication device.

The first acquisition device 251, the second acquisition device 252 and the third acquisition device 253 can identify the location of the current mobile terminal 200. In Embodiment 1, the first acquisition device 251 is a Global Positioning System (GPS) receiver. The second acquisition device 252 is an acceleration sensor. The third acquisition device 253 is a gyro sensor.

Various types of software are installed in the control device 280. The control device 280 controls the operation of the mobile terminal 200 by executing various types of software.

The storage device 290 stores various information. For example, the storage device 290 stores the information received by the cellular communication device 225, the first communication device 221, the second communication device 222 and the third communication device 223. The storage device 290 stores the information acquired by the first acquisition device 251, the second acquisition device 252 and the third acquisition device 253. The storage device 290 stores the information generated through control of the control device 280.

The vehicle management system 300 is implemented by a server such as a cloud server. The vehicle management system 300 estimates the SOC of the power storage device 150. The vehicle management system 300 may be referred to as the estimation device. The vehicle management system 300 includes communication equipment 320, a control device 380 and a storage device 390. The communication equipment 320 includes a first communication device 321.

The mobile terminal 200 communicates with the electric vehicle 100. The mobile terminal 200 communicates with the vehicle management system 300 through a network 400. Specifically, the communication equipment 220 communicates with the communication equipment 120. The communication equipment 220 communicates with the communication equipment 320 through the network 400. More specifically, the first communication device 221 communicates with the first communication device 121. The second communication device 222 communicates with the second communication device 122. The third communication device 223 communicates with the third communication device 123. The communication equipment 220 communicates with the first communication device 321 through the network 400. Specifically, in Embodiment 1, the communication devices in the communication equipment 220, which communicate with the first communication device 321 through the network 400 are the cellular communication device 225 or the third communication device 223 (WiFi communication device). The network 400 is e.g., the Internet.

The control device 380 estimates the travel distance of the electric vehicle 100 and the SOC of the power storage device 150.

The storage device 390 stores various information. For example, the storage device 390 stores the information received by the first communication device 321. The storage device 390 stores the information generated through control of the control device 380.

Hereinafter, the control of the operation of the mobile terminal 200 by the control device 280 will be described.

Communication software is installed in the control device 280. The communication software is specifically wireless communication software. The communication software controls the first communication device 221, the second communication device 222 and/or the third communication device 223. For example, the communication software controls ON/OFF of communication of the first communication device 221, the second communication device 222 and/or the third communication device 223. In addition, the communication software performs information processing related to the first communication device 221, the second communication device 222 and/or the third communication device 223.

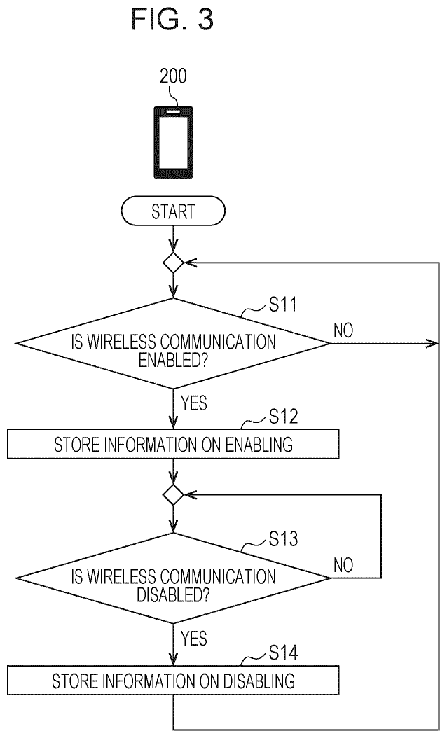

FIG. 3 is a flowchart for explaining the control by the communication software. In the description below, a communication device T may be the first communication device 221, or the second communication device 222, or the third communication device 223. In the flowchart in FIG. 3, “START” corresponds to the timing when communication performed by the communication device T is switched from OFF to ON. The control in the flowchart in FIG. 3 is completed when the communication performed by the communication device T is switched from ON to OFF.

In step S11, the control device 280 determines whether wireless communication between the communication device T and any communication partner is enabled. Here, “wireless communication is enabled” specifically indicates that the wireless communication has changed from disabled to enabled. When wireless communication between the communication device T and any communication partner is enabled, the flow proceeds to step S12. When no communication partner continues to have enabled wireless communication with the communication device T, step S11 is performed again.

In step S12, the control device 280 controls the mobile terminal 200 such that information on enabling is stored in the storage device 290. The information on enabling includes information indicating that wireless communication between the communication device T and the communication partner is enabled. The information on enabling includes e.g., the identifier of the communication partner of the communication device T. The information on enabling includes the time when wireless communication between the communication device T and the communication partner is enabled.

After step S12, in step S13, the control device 280 determines whether wireless communication between the communication device T and the communication partner is disabled. Here, “wireless communication is disabled” specifically indicates that the wireless communication has changed from enabled to disabled. When the wireless communication between the communication device T and the communication partner is disabled, the flow proceeds to step S14. When the wireless communication between the communication device T and the communication partner continues to be enabled, step S13 is performed again.

In step S14, the control device 280 controls the mobile terminal 200 such that information on disabling is stored in the storage device 290. The information on disabling includes e.g., information indicating that wireless communication between the communication device T and the communication partner is disabled. The information on disabling includes the identifier of the communication partner of the communication device T before the communication is disabled. The information on disabling includes information indicating the time when wireless communication between the communication device T and the communication partner is disabled. After step S14, the flow returns to step S11.

First software is installed in the control device 280 in Embodiment 1. The first software controls the operation of the mobile terminal 200. Specifically, the first software controls the operation of the mobile terminal 200 in cooperation with the communication software.

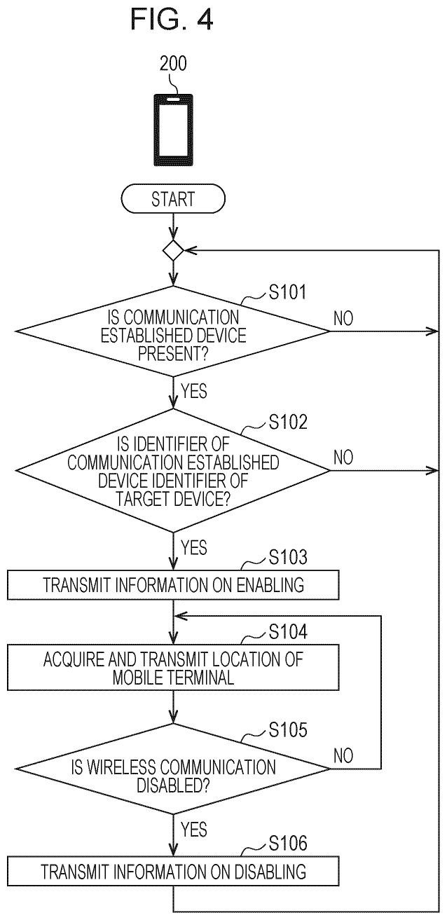

FIG. 4 is a flowchart for explaining the control by the first software. In Embodiment 1, the SOC of the power storage device 150 in the electric vehicle 100 is an estimation target. In the description below, a target device D is a device provided in the electric vehicle 100. The target device D may be the first device 111, or the second device 112, or the third device 113. The control in FIG. 4 is performed regardless of whether the user 30 is riding the electric vehicle 100 or not. Specifically, the control in FIG. 4 may be performed all the time.

In step S101, the control device 280 searches for a device (hereinafter referred to as a communication established device) for which established communication with the communication device T is detected, thus determines whether a communication established device is present. Here, “established communication is detected” specifically indicates that change from a state where communication is not established to a state where communication is established is detected. When a communication established device is present, the flow proceeds to step S102. When no device continues to have enabled wireless communication with the communication device T, step S101 is performed again.

Hereinafter, a first processing example and a second processing example are used as terms. The first processing example is a processing example associated with FIG. 3. The second processing example is another example of the first processing example. Each of the first processing example and the second processing example is exemplary processing belonging to Embodiment 1.

In the first processing example, the determination in step S101 of FIG. 4 is associated with the determination in step S11 of FIG. 3. Specifically, as described above, in step S12, information on enabling is stored in the storage device 290 according to the determination in step S11. In the first processing example, the control device 280 determines whether the information on enabling thus stored in the storage device 290 is present. When the information on enabling is present, a communication established device is determined to be present in step S101. In the second processing example, the determination in step S101 of FIG. 4 is performed independently from the determination in step S11 of FIG. 3. In step S101 according to the second processing example, information on enabling may be generated, and stored in the storage device 290.

When a communication established device is present, the communication device T receives the identifier of the communication established device from the communication established device. The received identifier is stored in the storage device 290. In the first processing example, storing of the identifier corresponds to step S12 of FIG. 3. In the second processing example, storing of the identifier is performed independently from step S12 of FIG. 3.

In step S102, the control device 280 determines whether the identifier of the communication established device is the identifier of the target device D. When the identifier of the communication established device is the identifier of the target device D, the flow proceeds to step S103. When the identifier of the communication established device is not the identifier of the target device D, the flow returns to step S101. As understood from the description above, information on enabling may be stored in the storage device 290 in step S12 according to the determination in step S11, and the information on enabling may include the identifier of a communication partner k of the communication device T. In step S102 according to the first processing example, the control device 280 uses the identifier thus stored in the storage device 290 as the identifier of the communication established device in step S102. In step S102 according to the second processing example, the control device 280 uses the identifier of the communication established device acquired by the search in step S101 as the identifier of the communication established device in step S102.

In Embodiment 1, before step S102 is performed, the identifier of the target device D is pre-stored in the storage device 290. Thus, the control device 280 can determine in step S102 whether the identifier of the communication established device is the identifier of the target device D. Because the identifier of the target device D is pre-stored in the storage device 290, it is easy to prevent a device similar to the target device D from causing an unintentional operation of the control device 280. The device similar to the target device D is e.g., a device different in application from the target device D.

In step S103, the control device 280 controls the mobile terminal 200 such that the communication equipment 220 transmits the information on enabling to the first communication device 321 through the network 400. The information on enabling includes information indicating that wireless communication between the communication established device and the communication device T is enabled. The information on enabling includes the identifier of the communication established device. In addition, the information on enabling includes the time when the wireless communication is enabled. In step S103 according to the first processing example, the information on enabling to be transmitted is the information on enabling stored in the storage device 290 in step S12. In step S103 according to the second processing example, the information on enabling to be transmitted is the information on enabling stored in the storage device 290 in step S101.

When “YES” in step S102, it has been confirmed that the communication established device is the target device D, thus the communication established device in the description of step 103 can be treated as the target device D. This point applies to steps 104 to S106 described later.

As understood from the description above, the information on enabling in step S12 of FIG. 3 is information related to enabling of the wireless communication between the communication device T and any communication partner. The information on enabling related to enabling of the wireless communication between the communication device T and any communication partner may be referred to as the information on enabling any partner. In contrast, the information on enabling in step S103 of FIG. 4 is information related to enabling of the wireless communication between the target device D and the communication device T. The information on enabling related to enabling of the wireless communication between the target device D and the communication device T may be referred to as the information on enabling target.

Next, in step S104, the control device 280 acquires the current location of the mobile terminal 200 using the positional information acquisition device 250. The control device 280 then controls the mobile terminal 200 such that the acquired location is transmitted from the communication equipment 220 to the first communication device 321 through the network 400.

Next, in step S105, the control device 280 determines whether wireless communication between the communication established device and the communication device T is disabled. When the wireless communication is disabled, the flow proceeds to step S106. When the wireless communication continues to be enabled, the flow returns to step S104.

In the first processing example, the determination in step S105 of FIG. 4 is associated with the determination in step S13 of FIG. 3. Specifically, as described above, information on disabling is stored in the storage device 290 in step S14 according to the determination in step S13. In the first processing example, the control device 280 determines whether the information on disabling thus stored in the storage device 290 is present. When the information on disabling is present, the wireless communication is determined to be disabled in step S105. In the second processing example, the determination in step S105 of FIG. 4 is performed independently from the determination in step S13 of FIG. 3. In step S105 according to the second processing example, information on disabling may be generated, and stored in the storage device 290.

In step S106, the control device 280 controls the mobile terminal 200 such that the communication equipment 220 transmits the information on disabling to the first communication device 321 through the network 400. The information on disabling includes information indicating that wireless communication between the communication established device and the communication device T is disabled. The information on disabling includes the identifier of the communication established device which has performed wireless communication with the communication device T. The information on disabling includes the time when the wireless communication is disabled. After step S106, the flow returns to step S101. In step S106 according to the first processing example, the information on disabling to be transmitted is the information on disabling stored in the storage device 290 in step S14. In step S106 according to the second processing example, the information on disabling to be transmitted is the information on disabling stored in the storage device 290 in step S105.

As understood from the description above, the information on disabling in step S14 of FIG. 3 is information related to disabling of the wireless communication between the communication device T and any communication partner. The information on disabling related to disabling of the wireless communication between the communication device T and any communication partner may be referred to as the information on disabling any partner. In contrast, the information on disabling in step S105 and step S106 of FIG. 4 is information related to disabling of the wireless communication between the target device D and the communication device T. The information on disabling related to disabling of the wireless communication between the target device D and the communication device T may be referred to as the information on disabling target.

Hereinafter, a first communication example, a second communication example and a third communication example will be described with reference to FIG. 1. In FIG. 1, a dotted line arrow 61 indicates the movement of the user 30 before the user 30 rides the electric vehicle 100. A solid line arrow 62 indicates the movement of the user 30 when the user 30 is riding the electric vehicle 100. A dotted line arrow 63 indicates the movement of the user 30 after the user 30 gets out the electric vehicle 100.

In the first communication example, the target device D is the first device 111, and related to entertainment. The first communication device 121 and the first communication device 221 are Bluetooth communication devices. The wireless communication between the target device D and the mobile terminal 200 is the wireless communication between the first communication device 121 and the first communication device 221. The identifier of the target device D which has enabled wireless communication with the mobile terminal 200 is the identifier of the first device 111 which has enabled wireless communication with the first communication device 221.

Hereinafter, the following expression may be used: “the first communication device 121 and the first communication device 221 are in a proximity state”. Specifically, this expression indicates that the distance between the first communication device 121 and the first communication device 221 is within a communication range. Hereinafter, the following expression may be used: “the first communication device 121 and the first communication device 221 are in a separate state”. Specifically, this expression indicates that the distance between the first communication device 121 and the first communication device 221 is outside the communication range. These points apply to the expression that “the second communication device 122 and second the communication device 222 are in a proximity state”, the expression that “the second communication device 122 and the second the communication device 222 are in a separate state”, the expression that “the third communication device 123 and the third communication device 223 are in a proximity state”, and the expression that “the third communication device 123 and the third communication device 223 are in a separate state”.

In the first communication example, the user 30 carrying the mobile terminal 200 gets in the electric vehicle 100 at the location 51 of FIG. 1. Thus, the first communication device 121 and the first communication device 221 make a transition from a separate state to a proximity state. When the state transition is made while the first device 111 is powered on, wireless communication between the first communication device 121 and the first communication device 221 changes from enabled to disabled, thus determination of “YES” is made in steps S11, S101 and S102. Thus, steps S12, S103 and S104 are performed. Subsequently, the user 30 and the mobile terminal 200 move in the electric vehicle 100 from the location 51 to the location 52 along the road 50.

In the first communication example, the user 30 carrying the mobile terminal 200 gets out the electric vehicle 100 at the location 52 in FIG. 1. Thus, the first communication device 121 and the first communication device 221 make a transition from a proximity state to a separate state. Due to this state transition, the wireless communication between the first communication device 121 and the first communication device 221 changes from enabled to disabled, thus determination of “YES” is made in steps S13 and S105. Thus, steps S14 and S106 are performed.

Alternatively, in the first communication example, the user 30 switches the power source of the electric vehicle 100 or the power source of the first device 111 from ON to OFF at the location 52 in FIG. 1. Due to this switching, the wireless communication between the first communication device 121 and the first communication device 221 changes from enabled to disabled, thus determination of “YES” is made in steps S13 and S105. Thus, steps S14 and S106 are performed. Subsequently, the user 30 carrying the mobile terminal 200 gets out the electric vehicle 100.

In a specific example of the first communication example, pairing between the first communication device 121 and the first communication device 221 is already executed before the user 30 gets in the electric vehicle 100. With the pairing already executed and during power-on of the first device 111, when the first communication device 121 and the first communication device 221 make a transition from a separate state to a proximity state, the first communication device 121 and the first communication device 221 recognize each other, thus enabled state information and the identifier of the first device 111 are acquired. In another specific example of the first communication example, pairing is executed during the period since the user 30 gets in the electric vehicle 100 until the user 30 travels in the electric vehicle 100, thus enabled state information and the identifier of the first device 111 can be acquired.

In the second communication example, the target device D is the second device 112, and holds the mobile terminal 200. The second communication device 122 and the second communication device 222 are RF tag communication devices. The wireless communication between the target device D and the mobile terminal 200 is the wireless communication between the second communication device 122 and the second communication device 222. The identifier of the target device D which has enabled wireless communication with the mobile terminal 200 is the identifier of the second device 112 which has enabled wireless communication with the second communication device 222.

In the second communication example, the user 30 carrying the mobile terminal 200 gets in the electric vehicle 100 at the location 51 of FIG. 1. Thus, the second communication device 122 and the second communication device 222 make a transition from a separate state to a proximity state. Due to this state transition, wireless communication between the second communication device 122 and the second communication device 222 changes from disabled to enabled, thus determination of “YES” is made in steps S11, S101 and S102. Thus, steps S12, S103 and S104 are performed. Subsequently, the user 30 switches the power source of the electric vehicle 100 from OFF to ON, and the user 30 and the mobile terminal 200 move in the electric vehicle 100 from the location 51 to the location 52 along the road 50.

In the second communication example, the user 30 switches the power source of the electric vehicle 100 from ON to OFF at the location 52 of FIG. 1. The user 30 carrying the mobile terminal 200 gets out the electric vehicle 100. Thus, the second communication device 122 and the second communication device 222 make a transition from a proximity state to a separate state. Due to this state transition, the wireless communication between the second communication device 122 and the second communication device 222 changes from enabled to disabled, thus determination of “YES” is made in steps S13 and S105. Thus, steps S14 and S106 are performed.

As described above, in the second communication example, the user 30 carrying the mobile terminal 200 gets in the electric vehicle 100, thus the second communication device 222 (RF tag communication device) of the mobile terminal 200 and the second communication device 122 (RF tag communication device) of the electric vehicle 100 approach each other within the communication range. Also, the user 30 carrying the mobile terminal 200 gets out the electric vehicle 100, thus the second communication device 222 of the mobile terminal 200 and the second communication device 122 of the electric vehicle 100 are separated from each other outside the communication range. Although not particularly limited, in a specific example, the above-mentioned proximity state involves placement of the mobile terminal 200 on a predetermined cradle provided with the second communication device 122. The cradle is an example of the second device 112, and serves as a retainer of the mobile terminal 200. The above-mentioned separate state involves removal of the mobile terminal 200 from the predetermined cradle provided with the second communication device 122 and carrying the mobile terminal 200. This specific example using the cradle is compatible with the second communication example using the second communication device 222 and the second communication device 122 which are passive devices. However, in the second communication example, use of a cradle is not required. For example, even when the user 30 gets in and out the electric vehicle 100 with the mobile terminal 200 in his/her pocket, the second communication example applies.

In the third communication example, the target device D is the third device 113, and an in-vehicle camera. The third communication device 123 and the third communication device 223 are WiFi communication devices. The wireless communication between the target device D and the mobile terminal 200 is the wireless communication between the third communication device 123 and the third communication device 223. The identifier of the target device D which has enabled wireless communication with the mobile terminal 200 is the identifier of the third device 113 which has enabled wireless communication with the third communication device 223.

In the third communication example, the user 30 carrying the mobile terminal 200 gets in the electric vehicle 100 at the location 51 of FIG. 1. Thus, the third communication device 123 and the third communication device 223 make a transition from a separate state to a proximity state. When the state transition is made while the third device 113 is powered on, the wireless communication between the third communication device 123 and the third communication device 223 changes from enabled to disabled, thus determination of “YES” is made in steps S11, S101 and S102. Thus, steps S12, S103 and S104 are performed. Subsequently, the user 30 and the mobile terminal 200 move in the electric vehicle 100 from the location 51 to the location 52 along the road 50.

In the third communication example, the user 30 carrying the mobile terminal 200 gets out the electric vehicle 100 at the location 52 in FIG. 1. Thus, the third communication device 123 and the third communication device 223 make a transition from a proximity state to a separate state. Due to this state transition, the wireless communication between the third communication device 123 and the third communication device 223 changes from enabled to disabled, thus determination of “YES” is made in steps S13 and S105. Thus, steps S14 and S106 are performed.

Alternatively, in the third communication example, the user 30 switches the power source of the electric vehicle 100 or the power source of the third device 113 from ON to OFF at the location 52 in FIG. 1. Due to this switching, the wireless communication between the third communication device 123 and the third communication device 223 changes from enabled to disabled, thus determination of “YES” is made in steps S13 and S105. Thus, steps S14 and S106 are performed. Subsequently, the user 30 carrying the mobile terminal 200 gets out the electric vehicle 100.

Transmission of the current location of the mobile terminal 200 is repeated by repeating step S104 of FIG. 4. In this manner, positional information of the mobile terminal 200 is transmitted from the communication equipment 220 of the mobile terminal 200 to the first communication device 321 of the vehicle management system 300. Here, the positional information of the mobile terminal 200 is information including the location of the mobile terminal 200 at multiple timings. In the example of FIG. 4, the positional information of the mobile terminal 200 is information including the location of the mobile terminal 200 acquired in multiple steps S104.

As described above, the wireless communication between the target device D and the mobile terminal 200 is switched between disabled and enabled. The period from a timing of switching from disabled to enabled to a timing of switching from enabled to disabled is information indicating the period in which the target device D and the mobile terminal 200 are in proximity to each other, in other words, the period in which the mobile terminal 200 is moved with the electric vehicle 100. Thus, the vehicle management system 300 is provided with information which allows the travel distance of the electric vehicle 100 to be estimated by transmission of the positional information of the mobile terminal 200 based on step S104, transmission of the information on enabling in step S103, and transmission of the information on disabling in step S105, the travel distance being indicated by the solid line arrow 62 in FIG. 1. In this manner, even when movement of the mobile terminal 200 unrelated to the move of the electric vehicle 100 is made, the travel distance of the electric vehicle 100 can be estimated by the vehicle management system 300, the movement being indicated by the dotted line arrows 61 and 63.

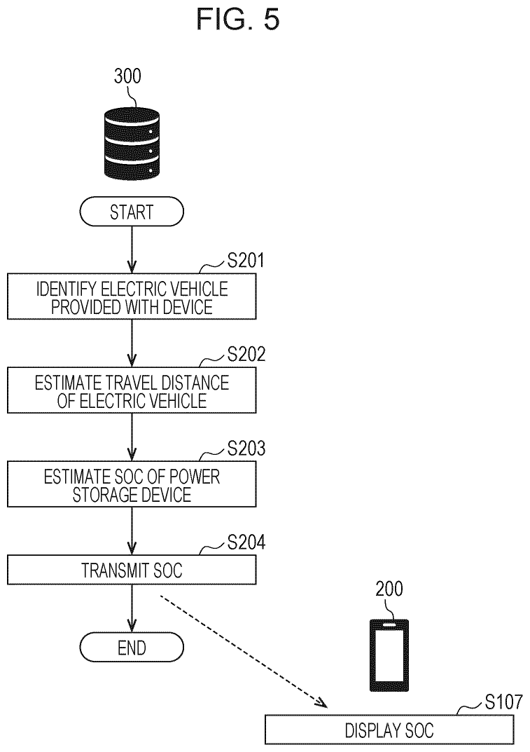

Hereinafter, estimation of the SOC of the power storage device 150 by the vehicle management system 300 will be described with reference to FIG. 5. FIG. 5 is a flowchart for explaining estimation of the SOC of the power storage device 150 by the vehicle management system 300 according to Embodiment 1. In Embodiment 1, the control cycle illustrated in FIG. 5 is repeated. Typically, the control cycle is repeated in a predetermined control cycle.

As described above, in step S103 of FIG. 4, the identifier of the communication established device, received by the first communication device 321 can be treated as the identifier of the target device D. In step S201 of FIG. 5, the control device 380 identifies the electric vehicle 100 provided with the target device D based on the identifier. Specifically, the storage device 390 stores the identifier of the target device D and the identifier of the electric vehicle 100 in association with each other. The control device 380 identifies the identifier of the electric vehicle 100 associated with the identifier of the target device D based on the correspondence relationship, and identifies the electric vehicle 100 provided with the target device D.

As described above, the information on enabling and the information on disabling received by the first communication device 321 in steps S103 and S106 of FIG. 4 can be treated as the information on enabling target and the information on disabling target. After step S201 of FIG. 5, in step S202, the control device 380 estimates the travel distance of the electric vehicle 100 based on the positional information of the mobile terminal 200, the information on enabling target, and the information on disabling target. Specifically, the positional information indicates multiple locations, and these multiple locations represent temporal change of the location of the mobile terminal 200, thus the path of the movement of the mobile terminal 200 can be grasped from the temporal change. More specifically, the above-mentioned multiple locations are discrete, and a polyline acquired by connecting those discrete locations in time series is considered to correspond to the path of the movement of the mobile terminal 200. As described above, the information on enabling target includes the time when wireless communication between the target device D and the communication device T is enabled, and the information on disabling target includes the time when wireless communication between the target device D and the communication device T is disabled. The path length from the location of the mobile terminal 200 at the former time indicated by the positional information to the location of the mobile terminal 200 at the latter time indicated by the positional information is estimated as the travel distance. This estimated value can be treated as an estimated value of the travel distance of the electric vehicle 100. That is, in step S202, the control device 380 estimates the travel distance of the electric vehicle 100.

After step S202, in step S203, the control device 380 estimates the SOC of the power storage device 150 mounted on the electric vehicle 100 based on the estimated travel distance of the electric vehicle 100.

In an estimation example, the SOC is estimated in step S203 as follows. Specifically, the control device 380 estimates a decrease in the SOC based on the travel distance of the electric vehicle 100, estimated in step S202 in the current control cycle. The control device 380 subtracts the above-mentioned decrease from the estimated value of SOC in step S203 in the previous control cycle. Thus, the SOC is estimated in step S203 in the current control cycle.

In the environment 10, timing may occur when the SOC of the power storage device 150 is known. In the above-mentioned estimation example, it is useful for the control device 380 to recognize the above-mentioned known SOC and timing. This is because the SOC in step S203 in the current control cycle can be estimated by estimating the above-mentioned decrease in each control cycle, and successively subtracting the decrease from the above-mentioned known SOC.

In a first configuration example, information indicating the timing (hereinafter, referred to as a specific timing) when the electric vehicle 100 has finished charging at a charging station 55 is transmitted from the charging station 55 to the vehicle management system 300.

In a second configuration example, the user 30 makes a reservation for charging the electric vehicle 100 at the charging station 55 by application of the mobile terminal 200. The charging station 55 stores a history of reservation. Information indicating the timing (hereinafter, referred to as a specific timing) of completion of a reserved recharge period is transmitted from the mobile terminal 200 or the charging station 55 to the vehicle management system 300.

In a third configuration example, after the electric vehicle 100 is recharged at the charging station 55, the user 30 pays the charging fee by application of the mobile terminal 200. Information indicating the timing (hereinafter, referred to as a specific timing) of the payment is transmitted from the mobile terminal 200 or the charging station 55 to the vehicle management system 300.

In the first configuration example, the second configuration example and the third configuration example, in the control device 380, each specific timing is treated as a timing when the SOC of the power storage device 150 is known. The known SOC may be 100%, or may be less than 100%. The known SOC is, for example, a target SOC in charging.

In a fourth configuration example, the user 30 inputs the SOC of the power storage device 150 to the mobile terminal 200 by application of the mobile terminal 200. Information indicating the timing (hereinafter, referred to as a specific timing) of the input is transmitted from the mobile terminal 200 to the vehicle management system 300. In the control device 380, the specific timing is treated as the timing when the SOC of the power storage device 150 is known. The known SOC is the value that the user 30 inputs to the mobile terminal 200.

After step S203, in step S204, the control device 380 controls the vehicle management system 300 such that the communication equipment 320 transmits the SOC estimated in step S203 to the communication equipment 220.

After step S204, in step S107, the control device 280 of the mobile terminal 200 displays the SOC estimated in step S203 on a screen of the mobile terminal 200. In Embodiment 1, the SOC is stored in the storage device 290.

In Embodiment 1, the information management system is constructed, which includes the electric vehicle 100 on which the power storage device 150 is mounted. The mobile terminal 200 is an external terminal located outside the information management system, and not connected to the network of the information management system. The vehicle management system 300 is an external system located outside the information management system, and not connected to the network of the information management system. In Embodiment 1, the mobile terminal 200 and the vehicle management system 300 can estimate and manage the information on the SOC of the power storage device 150. Embodiment 1 is suitable for estimating and managing, outside the information management system, information on the SOC of the power storage device 150, the information management system being capable of acquiring state information of the power storage device from the memory in the power storage device 150 mounted on the electric vehicle 100.

In step S201 of Embodiment 1, the electric vehicle 100 provided with the target device D is identified based on the identifier of the target device D which has enabled wireless communication with the mobile terminal 200. This enables the electric vehicle 100 as an estimation target to be correctly identified, and the SOC of the power storage device 150 of the electric vehicle 100 to be estimated. According to this configuration, even when the user 30 rides another vehicle in addition to the electric vehicle 100 as an estimation target, the SOC of the power storage device 150 of the electric vehicle 100 as an estimation target can be estimated.

Hereinafter, some other embodiments will be described. Hereinafter, the common elements between the embodiment already described and the embodiment subsequently described are labeled with the same reference symbols, and a description may be omitted. The descriptions of the embodiments are applicable to each other unless the descriptions technically contradict. The embodiments may be combined to each other unless the embodiments technically contradict.

### Embodiment 2

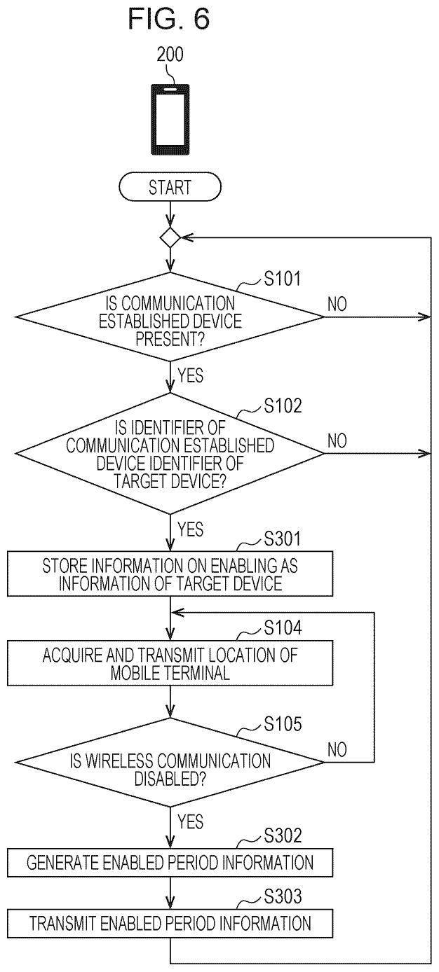

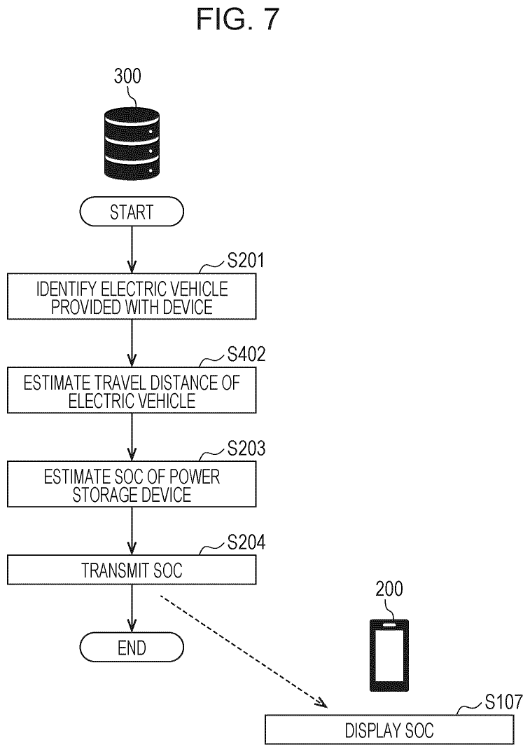

Hereinafter, Embodiment 2 will be described with reference to FIG. 6 and FIG. 7.

Instead of the first software, second software is installed in the control device 280 in Embodiment 1. The second software controls the operation of the mobile terminal 200. Specifically, the second software controls the operation of mobile terminal 200 in cooperation with the communication software.

FIG. 6 is a flowchart for explaining the control by the second software. The control in FIG. 6 is performed regardless of whether the user 30 is riding the electric vehicle 100 or not. Specifically, the control in FIG. 6 may be performed all the time.

In step S102 of Embodiment 2, when the identifier of the communication established device is the identifier of the target device D, the flow proceeds to step S301. In step S301, the control device 280 controls the mobile terminal 200 such that the information on enabling target is stored in the storage device 290 as the information on the target device D (in other words, as the information on enabling target). When the identifier of the communication established device is not the identifier of the target device D, the flow returns to step S101. Note that in Embodiment 2, when the identifier of the communication established device is determined not to be the identifier of the target device D in step S102, the information on the identifier of the communication established device acquired in step S101 may be discarded.

In step S105 of Embodiment 2, when the wireless communication between the communication established device and the communication device T is disabled, the flow proceeds to step S302. In step S302, the control device 280 generates enabled period information. The enabled period information includes information indicating the period in which wireless communication between the target device D and the mobile terminal 200 is enabled.

Specifically, in step S302, the control device 280 controls the mobile terminal 200 such that the information on disabling is stored in the storage device 290 as the information on the target device D (in other words, as the information on disabling target). Next, the control device 280 generates enabled period information based on the information on enabling target and the information on disabling target. Specifically, as described in Embodiment 1, the information on enabling target includes the time when wireless communication between the target device D and the communication device T is enabled. The information on disabling target includes the time when the wireless communication between the target device D and the communication device T is disabled. In step S302, the period in which the wireless communication is enabled in the enabled period information is calculated as the difference between these times. Note that for calculation of the period in which wireless communication is enabled, the time when wireless communication between the communication established device and the communication device T is enabled may be used, the time being included in the information on enabling stored in the storage device 290 in step S12. In the above-mentioned calculation, the time when the wireless communication between the communication established device and the communication device T is disabled may be used, the time being included in the information on disabling stored in the storage device 290 in step S14. As described above, the communication established device, the information on enabling and the information on disabling mentioned above when determination of “YES” is made in step S102 are the target device D, the information on enabling target and the information on disabling target, respectively.

After step S302, in step S303, the control device 280 controls the mobile terminal 200 such that the communication equipment 220 transmits the enabled period information to the first communication device 321.

Transmission of the current location of the mobile terminal 200 is repeated by repeating step S104 in FIG. 6. In this manner, the positional information of the mobile terminal 200 is transmitted from the communication equipment 220 of the mobile terminal 200 to the first communication device 321 of the vehicle management system 300.

As described above, the enabled period information includes information indicating the period in which the wireless communication between the target device D and the mobile terminal 200 is enabled. Thus, the vehicle management system 300 is provided with information which allows the travel distance of the electric vehicle 100 to be estimated by transmission of the positional information of the mobile terminal 200, and transmission of the enabled period information in step S303, the travel distance being indicated by the solid line arrow 62 in FIG. 1. In this manner, even when movement of the mobile terminal 200 unrelated to the move of the electric vehicle 100 is made, the travel distance of the electric vehicle 100 can be estimated by the vehicle management system 300, the movement being indicated by the dotted line arrows 61 and 63.

FIG. 7 is a flowchart for explaining estimation of the SOC of the power storage device 150 by the vehicle management system 300 according to Embodiment 2. In Embodiment 2, as in Embodiment 1, the control cycle illustrated in FIG. 7 is repeated. Typically, the control cycle is repeated in a predetermined control cycle.

In Embodiment 2, after step S201, in step S402, the control device 380 estimates the travel distance of the electric vehicle 100 based on the positional information of the mobile terminal 200, and the enabled period information. Specifically, as in Embodiment 1, the path of the movement of the mobile terminal 200 can be grasped from the positional information. The start time and the end time of the period in which the wireless communication between the target device D and the communication device T is enabled can be grasped from the enabled period information. The path length from the location of the mobile terminal 200 at the start time indicated by the positional information to the location of the mobile terminal 200 at the end time indicated by the positional information is estimated as the travel distance. This estimated value can be treated as an estimated value of the travel distance of the electric vehicle 100. That is, in step S402, the control device 380 estimates the travel distance of the electric vehicle 100. After step S402, the flow proceeds to step S203.

Various modifications can be applied to the embodiments described above.

In Embodiments 1 and 2 described above, the in-vehicle equipment 110 includes the first device 111, the second device 112 and the third device 113. The communication equipment 220 includes the first communication device 221, the second communication device 222 and the third communication device 223. The positional information acquisition device 250 includes the first acquisition device 251, the second acquisition device 252 and the third acquisition device 253. However, the in-vehicle equipment 110 may not include one or two selected from the group consisting of the first device 111, the second device 112 and the third device 113. The communication equipment 220 may not include one or two selected from the group consisting of the first communication device 221, the second communication device 222 and the third communication device 223. The positional information acquisition device 250 may not include one or two selected from the group consisting of the first acquisition device 251, the second acquisition device 252 and the third acquisition device 253.

In Embodiments 1 and 2, before step S102 in FIG. 4 is performed, the identifier of the target device D is pre-stored in the storage device 290. However, this configuration is not required. Hereinafter, a modification which does not require the configuration will be described.

In the modification, in the vehicle management system 300, the identifier of the target device D is pre-stored in the storage device 390. Step S102 of FIG. 4 is omitted. In step S103, the information on enabling of the communication established device is transmitted to the first communication device 321, and stored in the storage device 390. In step S106, the information on disabling of the communication established device is transmitted to the first communication device 321, and stored in the storage device 390. The control device 380 determines whether the identifier of the communication established device included in the information on enabling is the identifier of the target device D. When the identifier of the communication established device is the identifier of the target device D, in step S201 of FIG. 5, the control device 380 identifies the electric vehicle 100 provided with the target device D based on the identifier. In step S202, the information on enabling and the information on disabling used to estimate the travel distance of the electric vehicle 100 include the identifier of the communication established device, which has determined to be the identifier of the target device D.

This modification can also be applied to the flowchart of FIG. 6. In this case, step 102 of FIG. 6 is omitted. In the step 301, the information on enabling of the communication established device is stored in the storage device 290. The enabled period information generated in step 302 includes information indicating the period in which the wireless communication between the communication established device and the mobile terminal 200 is enabled. In step S303, in addition to the enabled period information of the communication established device, information including the identifier of the communication established device is transmitted from the communication equipment 220 to the first communication device 321. The enabled period information of the communication established device and information including the identifier of the communication established device are stored in the storage device 390 in association with each other. The control device 380 determines whether the identifier of the communication established device is the identifier of the target device D. When the identifier of the communication established device is the identifier of the target device D, in step S201 of FIG. 7, the control device 380 identifies the electric vehicle 100 provided with the target device D based on the identifier. The control device 380 uses the enabled period information corresponding to the identifier to estimate the travel distance of the electric vehicle 100 in step S402.

In Embodiment 1, the operation of the communication software and the operation of the first software may be associated with each other. For example, when the wireless communication is determined to be enabled in step S11, a communication established device may be determined to be present in step S101. Storing of the identifier explained in step S101 may correspond to step S12. The mobile terminal 200 may be controlled by the operation of the first software without depending on the communication software. For example, whether a communication established device is present may be determined through search of a communication established device by the operation of the first software without depending on the communication software. The identifier of the communication established device may be stored. These points related to the first software apply to the second software in Embodiment 2.

In the first communication example in Embodiments 1 and 2 described above, the control device 280 of the mobile terminal 200 may store information on enabling and information on disabling using the communication software. The control device 280 may determine a proximity state and a separate state between the user 30 and the target device D based on the information on enabling and the information on disabling using the first software or the second software. Depending on the performance of device detection of the communication software and/or the communication device T, determination of a proximity or separate state may not be what is intended. For example, a situation where the performance of device detection is too high is discussed. In this situation, even when the user 30 is too far from the electric vehicle 100 to be determined to move with the electric vehicle 100, the target device D may be detected. A modification suitable for avoiding such an unintended determination may be adopted. Hereinafter, the modification will be described.

Specifically, in the modification, the control device 280 detects the intensity of electric waves of the wireless communication between the communication device T and the communication device of the target device D using the communication software. The control device 280 uses the first software or the second software to determine based on the information indicating the intensity of electric waves whether the user 30 is in proximity to the target device D of the particular electric vehicle 100 on which the user 30 rides. The information indicating the intensity of electric waves is, for example, information on electric field strength detected by the communication software.

Specifically, the electric field strength detected by the communication software correlates with the distance between the communication device T and the communication device of the target device D. When the detected electric field strength is higher than or equal to a threshold intensity, the control device 280 determines that the communication device T and the communication device of the target device D are in proximity to each other. Conversely, when the detected electric field strength is lower than a threshold intensity, the control device 280 determines that the communication device T and the communication device of the target device D are separated from each other. The threshold intensity may be preset to a level such that the communication device T and the communication device of the target device D can be determined to be in proximity to each other.

This technique can be applied to the control in the flowchart of FIG. 4. In an application example, the control device 280 controls the mobile terminal 200 such that when the detected electric field strength is higher than or equal to a threshold intensity, the communication equipment 220 transmits the information on enabling target to the first communication device 321 through the network 400 according to step S103. Meanwhile, when the detected electric field strength is lower than a threshold intensity, the transmission in step S103 is not performed.

This technique can be applied to the control in the flowchart of FIG. 6. In an application example, when the detected electric field strength is higher than or equal to a threshold intensity, the control device 280 controls the mobile terminal 200 such that the information on enabling target is stored in the storage device 290 according to step S301. Meanwhile, when the detected electric field strength is lower than a threshold intensity, the storing in step S301 is not made.

For this reason, the modification using the intensity of electric waves of wireless communication is useful in a situation where the performance of device detection is too high. According to the modification, the vehicle management system 300 can estimate the travel distance of the user 30 when riding on the electric vehicle 100 with higher accuracy.

The modification using the intensity of electric waves of the wireless communication is also useful in another situation. For example, in an environment such as a parking lot, a plurality of vehicles may be present. In such an environment, a situation may occur in which the devices mounted on a plurality of vehicles are detected by the communication software, and the user 30 is determined to be in proximity to each of the devices, thus the electric vehicle 100 on which the user 30 is riding cannot be detected properly. As described earlier, such a situation can be avoided by pre-storing the identifier of the target device D in the storage device 290. Such a situation can also be avoided by this modification. Specifically, this modification is superior to the above-described technique of pre-storing the identifier in that the above-mentioned situation is easily avoided even when the mobile terminal 200 of the user 30 responds to the in-vehicle equipment mounted on two or more vehicles among a plurality of vehicles. The advantage based on the superiority can be taken, for example, when two or more vehicles are parked in the parking lot of the home of the user 30. Note that the response is achieved, for example, by pairing with an in-vehicle equipment.

Specifically, a situation is discussed where the control device 280 detects enabled wireless communication between the communication device T and a plurality of devices using the communication software. In this case, the control device 280 treats the plurality of devices as communication established devices. The control device 280 then treats one of these communication established devices as the target device D, the one being in wireless communication with the communication device T with the highest electric field strength.

This technique can be applied to the control in the flowchart of FIG. 4 and FIG. 6. In an application example, when enabled wireless communication between the communication device T and a plurality of devices is detected in step S101, the control device 280 treats the plurality of devices as communication established devices. The control device 280 treats one of these communication established devices as the target device D, the one being in wireless communication with the communication device T with the highest electric field strength in step S102.

For this reason, the modification using the intensity of electric waves of wireless communication is useful in a situation where enabled wireless communication is performed between the communication device T and a plurality of devices. According to this modification, it is possible to more accurately estimate the travel distance of the electric vehicle 100 on which the user 30 is actually riding among a plurality of electric vehicles 100 equipped with devices with enabled wireless communication.

Thus, according to the modification, the intensity of electric waves in the wireless communication between the target device D and the mobile terminal 200 can be detected in the mobile terminal 200, and the identifier of the target device D can be transmitted to the vehicle management system 300 based on the detected intensity of electric waves.

Unless contradiction is caused, the above-described modification using the intensity of electric waves, specifically, the electric field strength is also applicable to the third communication example. Both the technique of pre-storing the identifier of the target device D in the storage device 290 and the above-described modification using the intensity of electric waves, specifically, the electric field strength may be adopted.

A configuration may be adopted in which the control using the intensity of electric waves, specifically, the electric field strength is performed in the vehicle management system 300. Hereinafter, a modification will be described in which this configuration is applied to a first embodiment (corresponding to the first software) or a second embodiment (corresponding to the second software). In the first software or the second software according to the modification, the intensity of electric waves of the wireless communication between the communication device T and the communication device of the target device D is not considered. Meanwhile, in the vehicle management system 300, the intensity of electric waves of the wireless communication between the communication device T and the communication device of the target device D is considered.

Specifically, in the modification of the first embodiment, in step S103 of FIG. 4, in addition to the information on enabling, information indicating the intensity of electric waves of the wireless communication between the communication device T and the communication device of the target device D is transmitted from the communication equipment 220 to the first communication device 321, and stored in the storage device 390. In step S201 of FIG. 5, the electric vehicle 100 is identified based on the information indicating the intensity of electric waves and the identifier included in the information on enabling. For example, information indicating the detected electric field strength is transmitted from the communication equipment 220 to the first communication device 321, and stored in the storage device 390. In that case, the control device 380 can identify the electric vehicle 100 using the identifier included in the information on enabling transmitted with the information indicating the detected electric field strength from the communication equipment 220 to the first communication device 321 and stored in the storage device 390. Specifically, when the electric field strength detected from the information indicating the detected electric field strength is determined to be higher than or equal to a threshold value, the control device 380 identifies the electric vehicle 100 provided with the target device D based on the identifier. Meanwhile, when the electric field strength detected from the information indicating the detected electric field strength is determined to be lower than a threshold intensity, the control device 380 does not identify the electric vehicle 100 based on the identifier.

A situation is discussed where enabled wireless communication between the communication device T and a plurality of devices is detected by the communication software in the wireless communication mobile terminal 200. In an example, in this case, information indicating the detected electric field strength related to the devices is transmitted with the information on enabling related to the devices from the communication equipment 220 to the first communication device 321, and stored in the storage device 390. The control device 380 treats one of these devices as the target device D, the one with the highest detected electric field strength. In step S201 of FIG. 5, the control device 380 identifies the electric vehicle 100 provided with the target device D based on the identifier included in the information on enabling of the device treated as the target device D.

In the modification of the second embodiment, in step S303 of FIG. 6, in addition to the enabled period information, information including the identifier of the target device D and information indicating the intensity of electric waves of the wireless communication between the communication device T and the communication device of the target device D are transmitted from the communication equipment 220 to the first communication device 321. The enabled period information, the information including the identifier of the target device D, and the information indicating the intensity of electric waves of the wireless communication between the communication device T and the communication device of the target device D are stored in the storage device 390 in association with each other. In step S201 of FIG. 7, the electric vehicle 100 is identified based on the information indicating the intensity of electric waves and the identifier of the target device D. For example, information indicating the detected electric field strength is assumed to be transmitted from the communication equipment 220 to the first communication device 321, and stored in the storage device 390. In that case, the control device 380 can identify the electric vehicle 100 using the identifier of the target device D transmitted with the information indicating the detected electric field strength from the communication equipment 220 to the first communication device 321, and stored in the storage device 390. Specifically, when the electric field strength detected from the information indicating the detected electric field strength is determined to be higher than or equal to a threshold intensity, the control device 380 identifies the electric vehicle 100 provided with the target device D based on the identifier. Meanwhile, when the electric field strength detected from the information indicating the detected electric field strength is determined to be lower than a threshold intensity, the control device 380 does not identify the electric vehicle 100 based on the identifier.

A situation is discussed where enabled wireless communication between the communication device T and a plurality of devices is detected by the communication software in the mobile terminal 200. In an example, in this case, information indicating the detected electric field strength related to the devices and information including the identifiers of the devices are transmitted with the enabled period information related to the devices from the communication equipment 220 to the first communication device 321. The enabled period information related to the devices, the information indicating the detected electric field strength related to the devices, and the information including the identifiers of the devices are stored in the storage device 390 in association with each other. The control device 380 treats one of these devices as the target device D, the one with the highest detected electric field strength. In step S201 of FIG. 7, the control device 380 identifies the electric vehicle 100 provided with the target device D based on the identifier of the device treated as the target device D. The control device 380 uses the enabled period information corresponding to the identifier to estimate the travel distance of the electric vehicle 100 in step S402.

Thus, according to the modification, information indicating the intensity of electric waves in the wireless communication between the target device D and the mobile terminal 200 can be received in the vehicle management system 300, and the electric vehicle 100 provided with the target device D can be identified based on the identifier of the target device D and the information indicating the intensity of electric waves.

In both the first software or the second software, and the vehicle management system 300, the intensity of electric waves may be considered.

In Embodiments 1 and 2 described above, the power storage device 150 is a storage battery. However, the power storage device 150 may be a capacitor. The power storage device 150 may include both a storage battery and a capacitor.

In Embodiments 1 and 2 described above, the technique using the mobile terminal 200 has been illustrated. However, instead of the mobile terminal 200, a tablet, a personal digital assistant (PDA) and the like may be used. The technique in Embodiments 1 and 2 can be generalized by replacing the “mobile terminal 200” in the description of Embodiments 1 and 2 with the “information terminal”. The information terminal may be the mobile terminal 200, a tablet, a PDA and the like.

The timing when communication between any communication partner or the target device D and the communication device T is enabled, and the timing when the identifier of any communication partner or the target device D is received by the communication device T may be the same and may be different.

The order, content and the like of the steps of the above-described flowchart can be changed as appropriate. Part of the steps of the above-described flowchart may be omitted.

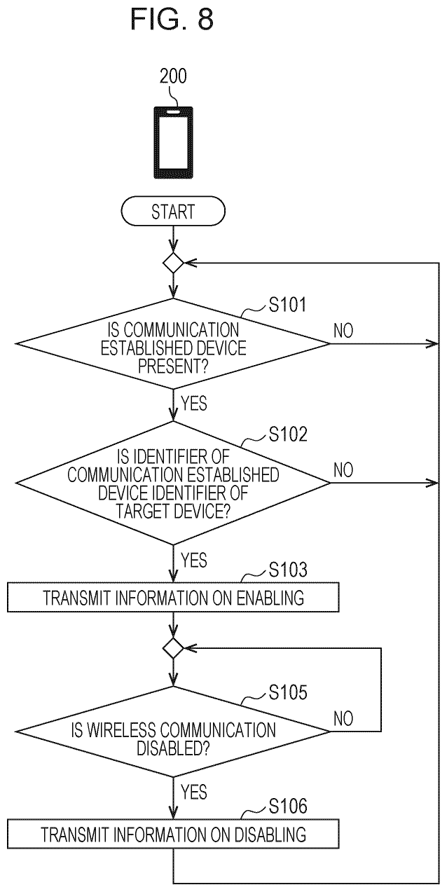

In Embodiment 1, step S104 of FIG. 4 is performed. However, this configuration is not required. In the modification illustrated in FIG. 8, instead of the first software, third software is installed in the control device 280. The third software controls the operation of the mobile terminal 200. Specifically, the third software controls the operation of the mobile terminal 200 in cooperation with the communication software. FIG. 8 is a flowchart for explaining the control by the third software. The control in FIG. 8 is performed regardless of whether the user 30 is riding the electric vehicle 100 or not. Specifically, the control in FIG. 8 may be performed all the time.

In the modification illustrated in FIG. 8, after step S103, the flow proceeds to step S105. When the wireless communication is disabled in the determination in step S105, the flow proceeds to step S106. When the wireless communication continues to be enabled, step S105 is performed again. In this modification, another process different from the process of the control device 280, performed by the third software repeats the transmission of the current location of the mobile terminal 200 to the vehicle management system 300. In this manner, positional information of the mobile terminal 200 is transmitted from the communication equipment 220 of the mobile terminal 200 to the first communication device 321 of the vehicle management system 300. Another process is performed, for example, by positional information management software installed in the mobile terminal 200.

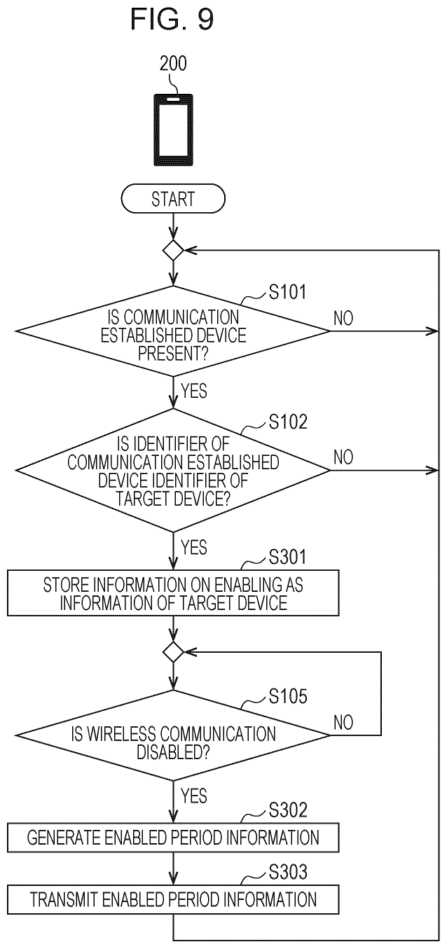

In Embodiment 2, step S104 of FIG. 6 is performed. However, this configuration is not required. In the modification illustrated in FIG. 9, instead of the second software, fourth software is installed in the control device 280. The fourth software controls the operation of the mobile terminal 200. Specifically, the fourth software controls the operation of the mobile terminal 200 in cooperation with the communication software. FIG. 9 is a flowchart for explaining the control by the fourth software. The control in FIG. 9 is performed regardless of whether the user 30 is riding the electric vehicle 100 or not. Specifically, the control in FIG. 9 may be performed all the time.

In the modification illustrated in FIG. 9, after step S301, the flow proceeds to step S105. When the wireless communication is disabled in the determination in step S105, the flow proceeds to step S302. When the wireless communication continues to be enabled, step S105 is performed again. In this modification, another process different from the process of the control device 280, performed by the fourth software repeats the transmission of the current location of the mobile terminal 200 to the vehicle management system 300. In this manner, positional information of the mobile terminal 200 is transmitted from the communication equipment 220 of the mobile terminal 200 to the first communication device 321 of the vehicle management system 300. Another process is performed, for example, by positional information management software installed in the mobile terminal 200.

In Embodiments 1 and 2 described above, the electric transportation (electric mobility) is the electric vehicle 100. In a modification, the electric transportation is an electric vessel. Replacement of a term in the description of Embodiments 1 and 2 with another term provides the description of a modification. The replacement includes replacing the “electric vehicle 100” with the “electric vessel”. The replacement may include replacing a “device related to entertainment” with a “fish finder”. However, in a modification, a “device related to entertainment” can be applied. Generally, in Embodiments 1 and 2 described above, the “electric vehicle 100” may be replaced with the “electric mobility”.

### APPENDIX

The following technique is disclosed by the description of the embodiments above.

### Technique 1

An estimation method comprising:
receiving, from an information terminal of a user of an electric vehicle, information indicating that wireless communication between a device provided in the electric vehicle and the information terminal is enabled;
receiving, from the information terminal, information indicating that wireless communication between the device and the information terminal is disabled;
receiving positional information of the information terminal from the information terminal;
estimating a travel distance of the electric vehicle based on the information indicating that the wireless communication is enabled, the information indicating that the wireless communication is disabled, and the positional information of the information terminal; and
estimating SOC of a power storage device mounted on the electric vehicle based on the estimated travel distance of the electric vehicle.

### Technique 2

An estimation method comprising:
receiving, from an information terminal of a user of an electric vehicle, information indicating a period in which wireless communication between a device provided in the electric vehicle and the information terminal is enabled;
receiving positional information of the information terminal from the information terminal;
estimating a travel distance of the electric vehicle based on the information indicating the period in which the wireless communication is enabled, and the positional information of the information terminal; and
estimating SOC of a power storage device mounted on the electric vehicle based on the estimated travel distance of the electric vehicle.

### Technique 3

The estimation method according to technique 1 or 2,
wherein the device relates to entertainment.

### Technique 4

The estimation method according to technique 1 or 2,
wherein the device holds the information terminal.

### Technique 5

The estimation method according to any one of techniques 1 to 4, further comprising:
transmitting information indicating the estimated SOC to the information terminal.

### Technique 6

The estimation method according to any one of techniques 1 to 5, further comprising:
receiving, from the information terminal, an identifier of the device which has enabled wireless communication with the information terminal; and
identifying the electric vehicle provided with the device based on the identifier.

### Technique 7

The estimation method according to technique 6, further comprising:
receiving, from the information terminal, information indicating an intensity of electric waves in wireless communication between the device and the information terminal; and
identifying the electric vehicle provided with the device based on the identifier and the information indicating the intensity of the electric waves.

### Technique 8

A method of controlling an information terminal which transmits information to an estimation device to estimate SOC by the estimation device using the estimation method according to technique 1, the method comprising:
transmitting, to the estimation device, information indicating that wireless communication between a device provided in an electric vehicle and an information terminal of a user of the electric vehicle is enabled;
transmitting, to the estimation device, information indicating that wireless communication between the device and the information terminal is disabled; and
transmitting positional information of the information terminal to the estimation device.

### Technique 9

A method of controlling an information terminal which transmits information to an estimation device to estimate SOC by the estimation device using the estimation method according to technique 2, the method comprising:
transmitting, to the estimation device, information indicating a period in which wireless communication between a device provided in an electric vehicle and the information terminal of a user of the electric vehicle is enabled; and
transmitting positional information of the information terminal to the estimation device.

### Technique 10

The method of controlling an information terminal according to technique 8 or 9, further comprising
receiving, from the estimation device, information indicating the SOC estimated by the estimation device.

### Technique 11

The method of controlling an information terminal according to technique 10, further comprising:
displaying the information indicating the received SOC on a screen of the information terminal.

### Technique 12

The method of controlling an information terminal according to any one of techniques 8 to 11, further comprising:
receiving an identifier of the device which has enabled wireless communication with the information terminal; and
transmitting the identifier of the device to the estimation device.

### Technique 13

The method of controlling an information terminal according to technique 12, further comprising:
detecting an intensity of electric waves in wireless communication between the device and the information terminal; and
transmitting the identifier of the device to the estimation device based on the detected intensity of the electric waves.

### Technique 14

An identification method comprising:
receiving an identifier of a device which is provided in an electric vehicle and has enabled wireless communication with an information terminal of a user of the electric vehicle;
receiving information indicating an intensity of electric waves in wireless communication between the device and the information terminal; and
identifying an electric vehicle provided with the device based on the identifier of the device and the information indicating the intensity of the electric waves.

The technique according to the present disclosure is applicable to the environment using an electric transportation.

What is claimed is:

1. An estimation method comprising:
receiving, from an information terminal of a user of an electric vehicle, information indicating that wireless communication between a device provided in the electric vehicle and the information terminal is enabled;
receiving, from the information terminal, information indicating that wireless communication between the device and the information terminal is disabled;
receiving positional information of the information terminal from the information terminal;
estimating a travel distance of the electric vehicle based on the information indicating that the wireless communication is enabled, the information indicating that the wireless communication is disabled, and the positional information of the information terminal; and
estimating SOC of a power storage device mounted on the electric vehicle based on the estimated travel distance of the electric vehicle.

2. An estimation method comprising:
receiving, from an information terminal of a user of an electric vehicle, information indicating a period in which wireless communication between a device provided in the electric vehicle and the information terminal is enabled;
receiving positional information of the information terminal from the information terminal;
estimating a travel distance of the electric vehicle based on the information indicating the period in which the wireless communication is enabled, and the positional information of the information terminal; and
estimating SOC of a power storage device mounted on the electric vehicle based on the estimated travel distance of the electric vehicle.

3. The estimation method according to claim 1,
wherein the device relates to entertainment.

4. The estimation method according to claim 1,
wherein the device holds the information terminal.

5. The estimation method according to claim 1, further comprising:
transmitting information indicating the estimated SOC to the information terminal.

6. The estimation method according to claim 1, further comprising:
receiving, from the information terminal, an identifier of the device which has enabled wireless communication with the information terminal; and
identifying the electric vehicle provided with the device based on the identifier.

7. The estimation method according to claim 6, further comprising:
receiving, from the information terminal, information indicating an intensity of electric waves in wireless communication between the device and the information terminal; and
identifying the electric vehicle provided with the device based on the identifier and the information indicating the intensity of the electric waves.

8. A method of controlling an information terminal which transmits information to an estimation device to estimate SOC by the estimation device using the estimation method according to claim 1, the method comprising:
transmitting, to the estimation device, information indicating that wireless communication between a device provided in an electric vehicle and an information terminal of a user of the electric vehicle is enabled;
transmitting, to the estimation device, information indicating that wireless communication between the device and the information terminal is disabled; and
transmitting positional information of the information terminal to the estimation device.

9. A method of controlling an information terminal which transmits information to an estimation device to estimate SOC by the estimation device using the estimation method according to claim 2, the method comprising:
transmitting, to the estimation device, information indicating a period in which wireless communication between a device provided in an electric vehicle and the information terminal of a user of the electric vehicle is enabled; and
transmitting positional information of the information terminal to the estimation device.

10. The method of controlling an information terminal according to claim 8, further comprising
receiving, from the estimation device, information indicating the SOC estimated by the estimation device.

11. The method of controlling an information terminal according to claim 10, further comprising:
displaying the information indicating the received SOC on a screen of the information terminal.

12. The method of controlling an information terminal according to claim 8, further comprising:
receiving an identifier of the device which has enabled wireless communication with the information terminal; and
transmitting the identifier of the device to the estimation device.

13. The method of controlling an information terminal according to claim 12, further comprising:
detecting an intensity of electric waves in wireless communication between the device and the information terminal; and
transmitting the identifier of the device to the estimation device based on the detected intensity of the electric waves.
